(19) United States
(12) Patent Application Publication
(10) Pub. No.: US 2022/0191740 A1
(43) Pub. Date: Jun. 16, 2022

(54) RADIO PACKET TRANSMISSION APPARATUS, RADIO PACKET TRANSMISSION METHOD, AND NON-TRANSITORY COMPUTER READABLE MEDIUM

(71) Applicant: NEC Corporation, Tokyo (JP)

(72) Inventor: Koichi NAKAGAWA, Tokyo (JP)

(73) Assignee: NEC Corporation, Tokyo (JP)

(21) Appl. No.: 17/598,351

(22) PCT Filed: Feb. 7, 2020
(86) PCT No.: PCT/JP2020/004851

§ 371 Date: Sep. 27, 2021

(30) Foreign Application Priority Data
Mar. 28, 2019 (JP) 2019-063950

(51) Int. Cl. H04W 28/18; H04W 72/04; H04L 65/40; H04L 5/00

(52) U.S. Cl. CPC H04W 28/18; H04W 72/042; H04L 5/0048; H04W 72/0446; H04L 29/08

(57) ABSTRACT

To provide a radio packet transmission apparatus that assures communication quality more reliably, a radio packet transmission method, and a non-transitory computer readable medium. A radio packet transmission apparatus (100A) is configured to: divide data when transmitting the data utilizing traffic bonding and generates a plurality of divided data; distribute the plurality of the divided data into respective radio lines (L2) and transmit the distributed data; determine whether or not the line quality of the radio line (L2) can be assured based on the assembly memory capacity information of the reception-side radio packet transmission apparatus (100A) and the line status notification indicating the status of the line setting of the radio line (L2) and, change the line setting of the radio line (L2) when determining that the line quality of the radio line (L2) cannot be assured.

### TECHNICAL FIELD

The present disclosure relates to a radio packet transmission apparatus, a radio packet transmission method, and a non-transitory computer readable medium.

### BACKGROUND ART

In a radio packet transmission network, a technique called traffic bonding which is a technique of virtually bundling a plurality of radio lines into one logical line is known. In the traffic bonding technique, in order to make effective use of a line bandwidth, transmission data is divided into fixed lengths at a physical layer in a transmission-side apparatus and the divided data are distributed in accordance with the bandwidth of each radio line. Hereinafter, the transmission data divided into fixed lengths are referred to as divided data.

Identifiers indicating information on the order of the data and the start and the end of the data are added to the divided data. Then, the divided data are distributed in an order according to the bandwidth of each line. Further, in a reception-side apparatus, the transmission data is restored in accordance with the information indicated by the identifiers added to the divided data.

However, when the difference in the bandwidth among the lines belonging to the traffic bonding of the transmission-side apparatus is large with respect to the capacity allocated for the transmission data in a memory of the reception-side apparatus (hereinafter referred to as “assembly memory capacity”), the divided data waiting to be assembled cannot be stored in the memory and hence, in some cases, the transmission data cannot be restored. When the amount of data that is actually transmitted is small with respect to the total line bandwidth secured for the traffic bonding, the difference in the bandwidth among the lines is also small and hence the transmission data can be restored. However, when the amount of data that is actually transmitted is large with respect to the total line bandwidth secured for traffic bonding, the difference in the bandwidth among the lines is also large and hence the transmission data cannot be restored, thus causing omission of the data that has been transmitted.

Therefore, in order to assure the communication quality, the transmission data needs to be reliably restored. In order to reliably restore the transmission data, a network needs to be designed such that the relationship between the assembly memory capacity and the difference in the bandwidth among the lines becomes well-balanced.

Patent Literature 1 discloses a technique of changing the assembly memory capacity of the reception-side apparatus depending on whether the data having a large frame size is temporarily transmitted or the data having a normal frame size is transmitted. By this configuration, it is possible to prevent omission of the transmission data.

### CITATION LIST

### Patent Literature

Patent Literature 1: Japanese Unexamined Patent Application Publication No. 2015-192270

### SUMMARY OF INVENTION

### Technical Problem

However, in the technique disclosed in Patent Literature 1, the assembly memory capacity of the reception-side apparatus needs to be changed. Therefore, when the assembly memory capacity of the reception-side apparatus cannot be changed, the communication quality cannot be reliably assured.

An object of the present disclosure is to provide a radio packet transmission apparatus capable of assuring communication quality more reliably, a radio packet transmission method, and a non-transitory computer readable medium.

### Solution to Problem

A radio packet transmission apparatus according to a first aspect includes: dividing means for dividing data when transmitting the data utilizing traffic bonding and generating a plurality of divided data;

line distribution means for distributing the plurality of the divided data into a plurality of radio transmission means provided for respective radio lines;

radio transmission means for transmitting the divided data distributed by the line distribution means to the radio line corresponding to the radio transmission means among the radio lines belonging to the traffic bonding;

radio reception means for receiving assembly memory capacity information of an opposing-side station indicating capacity allocated for transmission of the data in a memory of a reception-side radio packet transmission apparatus; and

line setting management means for controlling line setting of the radio line, wherein

the radio transmission means inputs a line status notification indicating a status of a line setting of the corresponding radio line to the line setting management means,

the radio reception means inputs the assembly memory capacity information of the opposing-side station to the line setting management means, and

the line setting management means determines whether or not the line quality of the radio line can be assured based on the line status notification and the assembly memory capacity information of the opposing-side station, and performs control of changing the line setting of the radio line when determining that the line quality of the radio line cannot be assured.

A radio packet transmission method according to a second aspect including performing, by a radio packet transmission apparatus, the steps of:

dividing data when transmitting the data utilizing traffic bonding and generating a plurality of divided data;

distributing the plurality of the divided data into respective radio lines and transmitting the plurality of the divided data to the respective radio lines;

receiving assembly memory capacity information of an opposing-side station indicating capacity allocated for transmitting the data in a memory of a reception-side radio packet transmission apparatus;

acquiring a line status notification indicating a status of a line setting of each radio line; and

determining whether or not the line quality of the radio line can be assured based on the line status notification and the assembly memory capacity information of the opposing-side station, and changing the line setting of the radio line when determining that the line quality of the radio line cannot be assured.

A non-transitory computer-readable medium according to a third aspect stores a program for causing a radio packet transmission apparatus to execute the processes of:

dividing data when transmitting the data to a radio transmission apparatus utilizing traffic bonding and generating a plurality of divided data;

distributing the plurality of the divided data into respective radio lines and transmitting the plurality of the divided data to the respective radio lines;

receiving assembly memory capacity information of an opposing-side station indicating capacity allocated for transmitting the data in a memory of a reception-side radio packet transmission apparatus;

acquiring a line status notification indicating a line status of the radio line; and

determining whether or not the line quality of the radio line can be assured based on the line status notification and the assembly memory capacity information of the opposing-side station, and changing the line setting of the radio line when determining that the line quality of the radio line cannot be assured.

### Advantageous Effects of Invention

A radio packet transmission apparatus that can assure communication quality more reliably, a radio packet transmission method, and a non-transitory computer readable medium can be provided.

### BRIEF DESCRIPTION OF DRAWINGS

FIG. 1 is a block diagram showing an example of a configuration of a radio packet transmission apparatus according to a first example embodiment of the present disclosure;

FIG. 2 is a block diagram showing an example of a configuration of a radio packet transmission apparatus according to a second example embodiment of the present disclosure;

FIG. 3 is a block diagram showing an example of a configuration of a line setting management unit of the radio packet transmission apparatus according to the second example embodiment of the present disclosure; and

FIG. 4 is a flowchart showing a radio packet transmission method according to the second example embodiment of the present disclosure.

### DESCRIPTION OF EMBODIMENTS

### First Example Embodiment

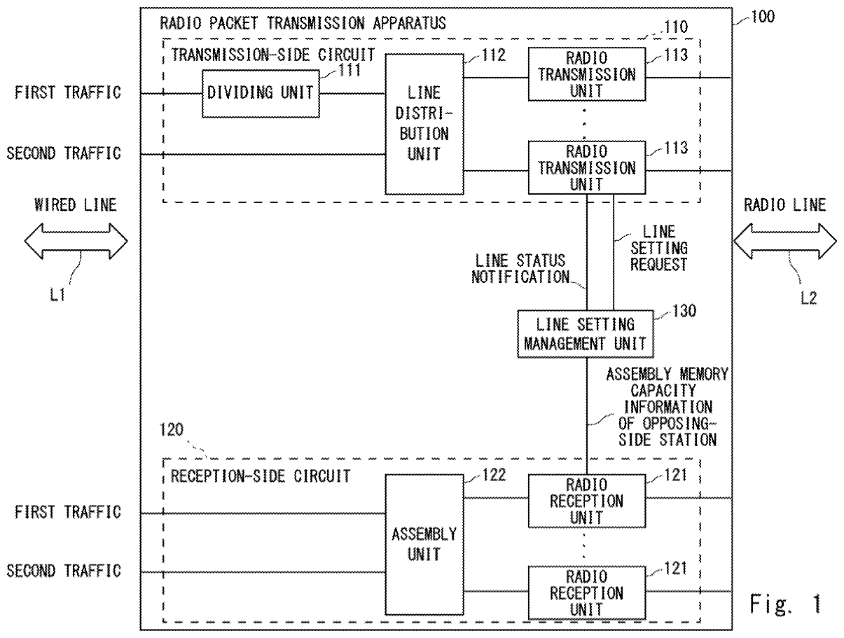

Hereinbelow, example embodiments of the present disclosure will be described with reference to the drawings. FIG. 1 is a block diagram showing an example of a configuration of a radio packet transmission apparatus 100 according to a first example embodiment of the present disclosure. As shown in FIG. 1, the radio packet transmission apparatus 100 includes a transmission-side circuit 110, a reception-side circuit 120, a line setting management unit 130, and the like.

The transmission-side circuit 110 includes a dividing unit 111, a line distribution unit 112, a plurality of radio transmission units 113, and the like. The radio transmission units 113 are provided for every radio line L2.

When data is transmitted using the traffic bonding, the dividing unit 111 divides the data to thereby generate a plurality of divided data.

The line distribution unit 112 distributes the plurality of the divided data into the plurality of the radio transmission units 113 provided for every radio line L2.

Each radio transmission unit 113 transmits the divided data distributed by the line distribution unit 112 to the corresponding radio line L2 among the radio lines L2 belonging to the traffic bonding. Further, each radio transmission unit 113 inputs a line status notification indicating the status of the line setting of the corresponding radio line L2 to the line setting management unit 130.

The reception-side circuit 120 includes a plurality of radio reception units 121, an assembly unit 122, and the like. The radio reception units 121 are provided for every radio line L2.

Each radio reception unit 121 receives the divided data from the corresponding radio line L2 and inputs the received divided data to the assembly unit 122. Further, each radio reception unit 121 inputs, to the line setting management unit 130, assembly memory capacity information of the opposing-side station indicating the capacity allocated for data transmission in the memory of the radio packet transmission apparatus 100 on the reception side.

The assembly unit 122 assembles the divided data input from each radio reception unit 121 and restores a first traffic, and the restored first traffic is transmitted to a wired line L1.

The line setting management unit 130 controls the line setting of the radio line L2 by inputting a line setting request to each radio transmission unit 113. Specifically, the line setting management unit 130 determines whether or not the line quality of the radio line L2 can be assured based on the line status notification and the assembly memory capacity information of the opposing-side station, and when it determines that the line quality of the radio line L2 cannot be assured, performs control to change the line setting of the radio line L2.

In the radio packet transmission apparatus 100 according to the first example embodiment described above, the line setting of the radio line L2 is changed by the line setting management unit 130 based on the assembly memory capacity information of the radio packet transmission apparatus 100 on the reception side and the line status notification indicating the status of the line setting of the radio line L2. In other words, the line setting of the radio line L2 belonging to the traffic bonding is optimized by the line setting management unit 130 in accordance with the assembly memory capacity of the radio packet transmission apparatus 100 on the reception side. Accordingly, the communication quality can be assured without having to change the assembly memory capacity of the radio packet transmission apparatus 100 on the reception side. Therefore, according to the radio packet transmission apparatus 100 according to the first example embodiment, it is possible to assure communication quality more reliably.

### Second Example Embodiment

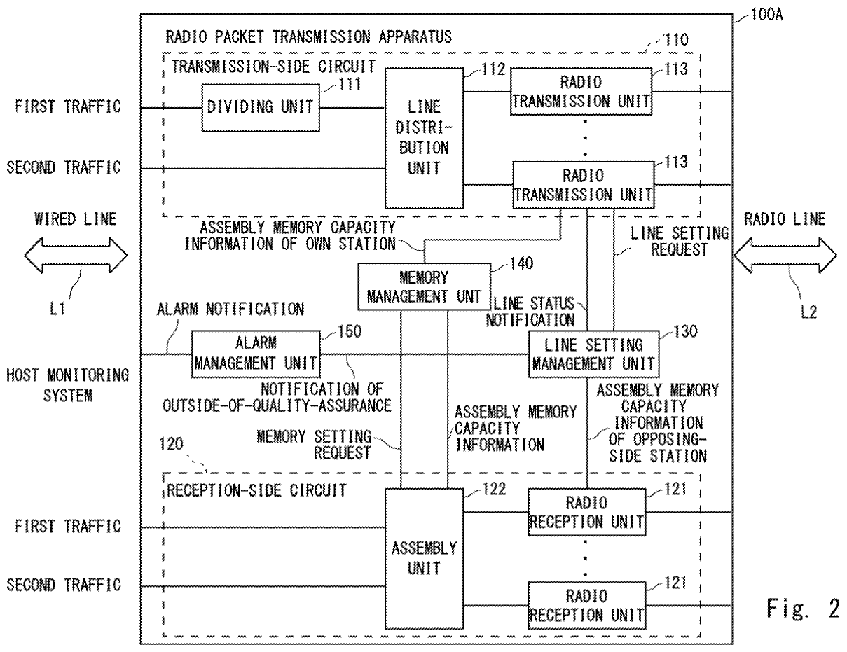

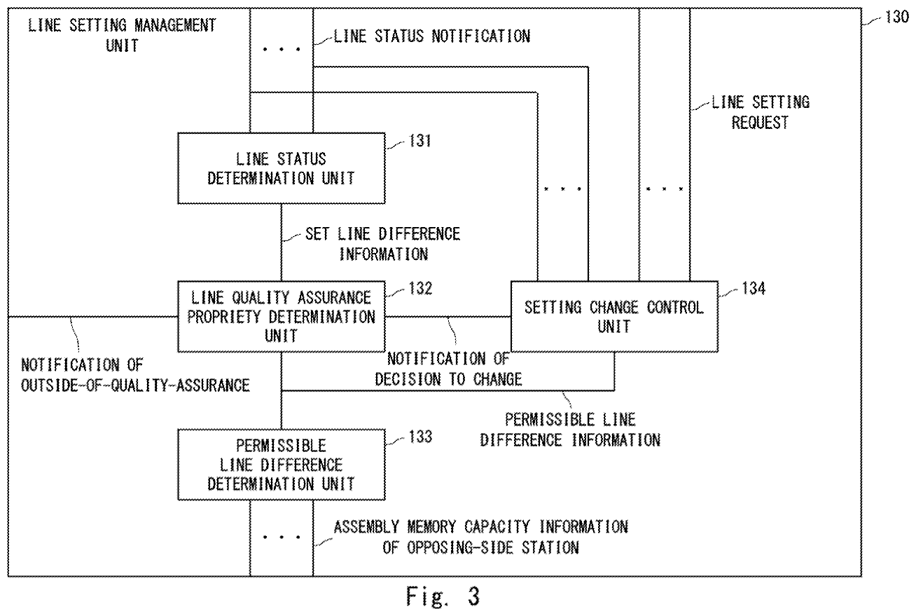

FIG. 2 is a block diagram showing an example of a configuration of a radio packet transmission apparatus 100A according to a second example embodiment of the present disclosure. FIG. 3 is a block diagram showing an example of a configuration of the line setting management unit 130 of the radio packet transmission apparatus 100A.

The radio packet transmission apparatus 100A according to the second example embodiment is communicatively connected with another radio packet transmission apparatus 100A through the radio line L2. Here, it is assumed that another radio packet transmission apparatus 100A has the same configuration as the radio packet transmission apparatus 100A according to the second example embodiment. For this reason, the identical reference symbols assigned to the structural elements of another radio packet transmission apparatus 100A denote identical structural elements of the radio packet transmission apparatus 100A according to the second example embodiment, and the redundant explanation thereof is omitted. However, the capacity allocated for the data transmission in a memory of another radio packet transmission apparatus 100A (hereinafter referred to as “assembly memory capacity”) may differ from that of the radio packet transmission apparatus 100A according to the second example embodiment. First, the configuration of the radio packet transmission apparatus 100A will be described hereinbelow.

As shown in FIG. 2, the radio packet transmission apparatus 100A includes the transmission-side circuit 110, the reception-side circuit 120, the line setting management unit 130, a memory management unit 140, an alarm management unit 150, and the like.

The transmission-side circuit 110 includes the dividing unit 111, the line distribution unit 112, a plurality of the radio transmission units 113, and the like. The radio transmission units 113 are provided for every radio line L2.

The dividing unit 111 divides the first traffic received from the wired line L1 by a fixed length in a physical layer and adds the information as regards the divided order, the beginning of the frame, the end of the frame (hereinafter referred to as “division information”) to the divided data. Further, the dividing unit 111 inputs the divided data to the line distribution unit 112. Here, the first traffic refers to the data received from the wired line L1 and to be transmitted to another radio packet transmission apparatus 100A using the traffic bonding.

The divided data obtained by dividing the first traffic is input from the dividing unit 111 to the line distribution unit 112. Further, the second traffic is input from the wired line L1 to the line distribution unit 112 without passing through the dividing unit 111. Here, the second traffic refers to the data received from the wired line L1 and to be transmitted to another radio packet transmission apparatus 100A using the traffic bonding.

The line distribution unit 112 distributes and inputs the divided data (the data obtained by dividing the first traffic) and the second traffic to the respective radio transmission units 113 in accordance with the bandwidth allocated to each radio transmission line L2. For instance, the line distribution unit 112 inputs the divided data by a round robin scheduling to each radio transmission unit 113. Further, the line distribution unit 112 inputs the second traffic to the radio transmission unit 113 of the radio line L2 designated in advance.

Each radio transmission unit 113 modulates data received from the line distribution unit 112 and transmits the modulated data to the corresponding radio line L2. Further, assembly memory capacity information of the own station is input from the memory management unit 140 to each radio transmission unit 113, and the line setting request is also input from the line setting management unit 130 to each radio transmission unit 113. Further, each radio transmission unit 113 inputs the line status notification indicating the line setting status of the radio line L2 to the line setting management unit 130.

The reception-side circuit 120 includes the plurality of the radio reception units 121, the assembly unit 122, and the like. The radio reception units 121 are provided for every radio line L2.

Each radio reception unit 121 demodulates the data received from the corresponding radio line L2 and inputs the demodulated data to the assembly unit 122. Further, each radio reception unit 121 inputs the assembly memory capacity information of the opposing-side station detected from the radio line L2 and inputs the detected information to the line setting management unit 130.

The assembly unit 122 determines whether or not the data input from the radio reception unit 121 is the divided data (the data obtained by dividing the first traffic in order to use the traffic bonding).

When the data input from the radio reception unit 121 is the divided data, the assembly unit 122 assembles the input divided data and restores the first traffic, and the restored first traffic is transmitted to the wired line L1.

When the data input from the radio reception unit 121 is undivided data, the assembly unit 122 transmits the input data as it is to the designated wired line L1. That is, when the data input from the radio reception unit 121 is the second traffic, the assembly unit 122 transmits the second traffic to the wired line L1.

Further, the assembly unit 122 inputs the memory capacity information indicating the assembly memory capacity of the memory of the radio packet transmission apparatus 100A to the memory management unit 140.

The line setting management unit 130, the memory management unit 140, and the alarm management unit 150 configure functional blocks that manage the transmission-side circuit 110 and the reception-side circuit 120 in common.

The line status notification is input from each radio transmission unit 113 to the line setting management unit 130. Further, the line setting management unit 130 inputs the line setting request to each radio transmission unit 113. Further, the assembly memory capacity information of the opposing-side station is input from each radio reception unit 121 to the line setting management unit 130. Further, the line setting management unit 130 inputs notification of outside-of-quality-assurance-range to the alarm management unit 150.

The memory management unit 140 manages the entire memory of the radio packet transmission apparatus 100A. Specifically, the memory management unit 140 manages the memory of the radio packet transmission apparatus 100A by inputting the memory setting request to the assembly unit 122. Further, the memory management unit 140 inputs the assembly memory capacity information input from the assembly unit 122 as the assembly memory capacity information of the own station to each radio transmission unit 113.

The alarm management unit 150 inputs an alarm notification to a host monitoring system in accordance with the notification of outside-of-quality-assurance-range input from the line setting management unit 130.

As shown in FIG. 3, the line setting management unit 130 includes a line status determination unit 131, a line quality assurance propriety determination unit 132, a permissible line difference determination unit 133, a setting change control unit 134, and the like.

From the radio transmission unit 113, the line status notification of the radio line L2 corresponding to the instant radio transmission unit 113 is input to the line status determination unit 131. Further, the line status determination unit 131 inputs set line difference information to the line quality assurance propriety determination unit 132 based on the line status notification.

The set line difference information is input from the line status determination unit 131 to the line quality assurance propriety determination unit 132, and the permissible line difference information is also input to the line quality assurance propriety determination unit 132 from the permissible line difference determination unit 133. Further, the line quality assurance propriety determination unit 132 inputs a notification of decision to change the line setting to the setting change control unit 134 based on the set line difference information and the permissible line difference information.

From the radio transmission unit 113, the line status notification of the radio line L2 corresponding to the instant radio transmission unit 113 is input to the setting change control unit 134. Further, the notification of decision to change the line setting is input from the line quality assurance propriety determination unit 132 to the setting change control unit 134, and the permissible line difference information is also input to the setting change control unit 134 from the permissible line difference determination unit 133. Then, the setting change control unit 134 decides the optimization setting based on the line status notification, the notification of decision to change the line setting, and the permissible line difference information. Further, the setting change control unit 134 inputs the optimization setting as the line setting request to the radio transmission unit 113 corresponding to the respective radio lines L2.

Next, the operation of the radio packet transmission apparatus 100A according to the second example embodiment will be described with reference to FIGS. 2 and 3. The radio packet transmission apparatus 100A transmits the first traffic among the plurality of traffic items received from the wired line L1 to another radio packet transmission apparatus 100A by using the traffic bonding. Further, the radio packet transmission apparatus 100A transmits the second traffic among the plurality of traffic items received from the wired line L1 to another radio packet transmission apparatus 100A without using the traffic bonding.

In the radio packet transmission apparatus 100A that has received a plurality of traffic items from the wired line L1 (hereinafter also referred to as “a radio packet transmission apparatus of the own station”), the dividing unit 111 divides the first traffic by a fixed length in a physical layer, adds the division information to the divided data, and inputs the instant divided data to which the division information is added to the line distribution unit 112.

Further, in the radio packet transmission apparatus 100A of the own station, the second traffic received from the wired line L1 is input to the line distribution unit 112 without being divided.

The line distribution unit 112 inputs each divided data by a round robin scheduling to the corresponding radio transmission unit 113. Specifically, the line distribution unit 112 distributes the divided data to the radio transmission unit 113 in accordance with the bandwidth of the radio line L2 corresponding to each radio transmission unit 113. Further, the line distribution unit 112 inputs the second traffic to the radio transmission unit 113 of the radio line L2 designated in advance.

The radio transmission unit 113 modulates the transmission data and transmits the modulated transmission data to the radio line L2.

Next, in another radio packet transmission apparatus 100A (hereinafter also referred to as a “radio packet transmission apparatus of an opposing-side station”), the radio reception unit 121 demodulates the transmission data received from the radio line L2 corresponding to the radio reception unit 121 and inputs the demodulated data to the assembly unit 122.

When the data input from the radio reception unit 121 is the divided data, the assembly unit 122 restores the data by combining the divided data based on the division information attached to the divided data, and transmit the restored data to the wired line L1. Further, when the data input from the radio reception unit 121 is undivided data (the second traffic), the assembly unit 122 transmits the input data as it is to the designated wired line L1.

Next, the operation of optimizing the setting of the radio line L2 in accordance with the assembly memory capacity of the memory of the radio packet transmission apparatus 100A of the opposing-side station (hereinafter also referred to as the “reception-side radio packet transmission apparatus) in the radio packet transmission apparatus 100A of the own station (hereinafter also referred to as the “transmission-side radio packet transmission apparatus”) will be described.

First, the assembly memory capacity of the reception-side radio packet transmission apparatus 100A is input to the transmission-side radio packet transmission apparatus 100A. Specifically, as shown in FIG. 2, the assembly unit 122 of the reception-side radio packet transmission unit 100A detects the assembly memory capacity of the internal memory and inputs the assembly memory capacity information indicating the assembly memory capacity to the memory management unit 140.

The memory management unit 140 of the reception-side radio packet transmission apparatus 100A manages the entire memory of the reception-side radio packet transmission apparatus 100A and also inputs the assembly memory capacity information input from the assembly unit 122 as the assembly memory capacity information of the own station to each radio transmission unit 113.

Each radio transmission unit 113 of the reception-side radio packet transmission apparatus 100A transmits the assembly memory capacity information of the own station to the transmission-side radio packet transmission apparatus 100A via the corresponding radio circuit L2. Note that each radio transmission unit 113 of the reception-side radio packet transmission apparatus 100A may transmit the assembly memory capacity information of the own station to the transmission-side radio transmission apparatus 100A by using the overhead for notification of the outbound information of the radio transmission or generating a frame for notification of the inbound information.

Each radio reception unit 121 of the transmission-side radio packet transmission apparatus 100A inputs the assembly memory capacity information of the own station transmitted from the reception-side radio packet transmission apparatus 100A via the corresponding radio circuit L2 as the assembly memory capacity information of the opposing-side station to the line setting management unit 130.

Further, each radio transmission unit 113 of the transmission-side radio packet transmission apparatus 100A monitors the status of the line setting of the radio line L2 and inputs the line status notification indicating the line status of the radio line L2 to the line setting management unit 130 on a regular basis.

The line setting management unit 130 compares the line status notification with the assembly memory capacity information of the opposing-side station and determines whether or not to change the line setting. When it is necessary to change the line setting of the radio line L2, the line setting management unit 130 inputs the line setting request to each radio transmission unit 113. When the line setting of the radio line L2 needs to be changed but cannot be changed, the line setting management unit 130 inputs a notification of outside-of-quality-assurance-range to the alarm management unit 150.

The alarm management unit 150 manages the alarms for the whole transmission-side radio packet transmission apparatus 100A. Further, when the notification of outside-of-quality-assurance-range is input from the line setting management unit 130, the alarm management unit 150 inputs the alarm notification indicating that the quality of the radio transmission is outside of the assured quality range to the host monitoring system.

Next, the operation of the line setting management unit 130 will be described with reference to FIG. 3. The permissible line difference determination unit 133 calculates the permissible line bandwidth difference (the permissible line speed difference) based on the assembly memory capacity information of the opposing-side station input from the radio reception unit 121 (the assembly memory capacity information of the own station transmitted from the transmission-side radio packet transmission apparatus 100A). Then, the permissible line difference determination unit 133 inputs the permissible line difference information indicating the permissible line speed difference to the line quality assurance propriety determination unit 132 and the setting change control unit 134.

On the other hand, the line status determination unit 131 detects the minimum bandwidth and the maximum bandwidth from among the line bandwidths allocated to the radio line L2 belonging to the traffic bonding based on the line status notification input from the radio transmission unit 113. Then, the line status determination unit 131 inputs the set line difference information indicating the set line difference which is the difference between the minimum bandwidth and the maximum bandwidth to the line quality assurance propriety determination unit 132.

The line quality assurance propriety determination unit 132 determines whether the set line difference indicated by the set line difference information input from the line status determination unit 131 falls within the range of a permissible line speed difference.

When the set line difference does not fall within the range of the permissible line speed difference, the line quality assurance propriety determination unit 132 determines whether or not the line setting of the radio line L2 can be changed. Then, when the line setting of the radio line L2 can be changed, the line quality assurance propriety determination unit 132 inputs the notification of decision to change the line setting to the setting change control unit 134. In other words, when the line quality cannot be assured and the line setting of the radio line L2 can be changed, the line quality assurance propriety determination unit 132 inputs the notification of decision to change the line setting to the setting change control unit 134.

Further, when the set line difference does not fall within the range of the permissible line speed difference and the line setting of the radio line L2 cannot be changed, the line quality assurance propriety determination unit 132 inputs the notification of outside-of-quality-assurance-range to the alarm management unit 150. In other words, when the line quality cannot be assured and the line setting of the radio line L2 cannot be changed, the line quality assurance propriety determination unit 132 inputs the notification of outside-of-quality-assurance-range to the alarm management unit 150.

When the notification of decision to change the line setting is input from the line quality assurance propriety determination unit 132, the setting change control unit 134 compares the permissible line difference information with the line status notification and decides the line setting which falls within the permissible line speed difference. Then, the setting change control unit 134 inputs the line setting request indicating the decided line setting to each radio transmission unit 113. Here, the line setting that falls within the permissible line speed difference refers to, for instance, a line setting in which the line bandwidth of the radio line for other traffic that does not utilize the traffic bonding such as the second traffic is decreased and the line bandwidth on the minimum bandwidth side of the radio line belonging to the traffic bonding is increased.

The radio transmission unit 113 changes the setting of the radio line L2 in accordance with the line setting request input from the setting change control unit 134.

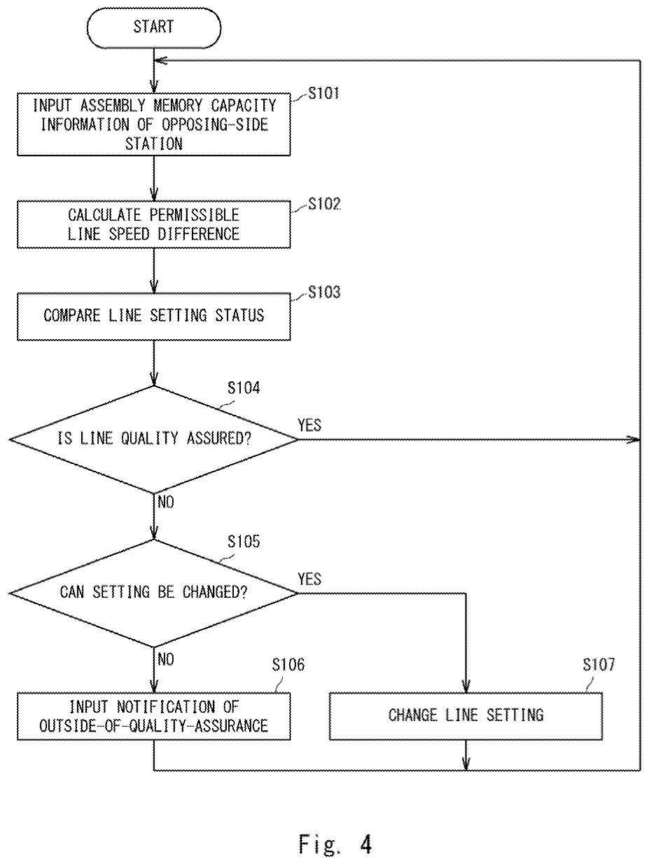

Next, a radio packet transmission method according to the second example embodiment will be described with reference to FIG. 4.

First, the assembly memory capacity information of the opposing-side station (the assembly memory capacity information transmitted from the reception-side radio packet transmission apparatus 100A) is input from each radio reception unit 121 to the permissible line difference determination unit 133 of the transmission-side packet transmission apparatus 100A (Step S101).

Next, the permissible line difference determination unit 133 calculates the permissible line bandwidth difference (the permissible line speed difference) based on the assembly memory capacity information of the opposing-side station (Step S102). Further, the permissible line difference determination unit 133 inputs the permissible line difference information indicating the permissible line speed difference to the line quality assurance propriety determination unit 132 and the setting change control unit 134.

Next, the line quality assurance propriety determination unit 132 compares the permissible line speed difference input in Step S102 with the set line status input from the line status determination unit 131 (Step S103). Specifically, the line quality assurance propriety determination unit 132 compares the permissible line speed difference input in Step S102 with the line status difference indicated by the set line difference information input from the line status determination unit 131.

Next, based on the result of the comparison in Step S103, the line quality assurance propriety determination unit 132 determines whether or not the line quality can be assured (Step S104). Specifically, the line quality assurance propriety determination unit 132 determines that line quality cannot be assured when the set line difference does not fall within the range of the permissible line speed difference.

In Step S104, when the line quality assurance propriety determination unit 132 determines that the line quality can be assured (Step S104; Yes), the process returns to Step S101.

In Step S104, when the line quality assurance propriety determination unit 132 determines that the line quality cannot be assured (Step S104; No), the line quality assurance propriety determination unit 132 determines whether or not the line setting of the radio line L2 can be changed (Step S105).

In Step S105, when the line setting of the radio line L2 cannot be changed (Step S105; No), the line quality assurance propriety determination unit 132 inputs the notification of outside-of-quality-assurance-range to the alarm management unit 150 (Step S106) and the process returns to Step S101.

In Step S105, when the line setting of the radio line L2 can be changed (Step S105; Yes), the line quality assurance propriety determination unit 132 inputs the notification of decision to change the line setting to the setting change control unit 134, the setting change control unit 134 inputs the line setting request to each radio transmission unit, and the radio transmission unit 113 changes the setting of the radio line L2 in accordance with the line setting request (Step S107) and the process returns to Step S101.

In accordance with the radio packet transmission apparatus 100A, the radio packet transmission method, and the program according to the second example embodiment described above, the same effect as that of the radio packet transmission apparatus 100 according to the first example embodiment can be obtained. Therefore, in accordance with the radio packet transmission apparatus 100A, the radio packet transmission method, and the program according to the second embodiment, the communication quality can be more reliably assured.

Specifically, when the traffic load of the radio line L2 is high in performing data transmission utilizing the traffic bonding, data can be transmitted in accordance the line bandwidth difference that can be assured by the memory of the reception-side radio packet transmission apparatus 100A (the permissible line speed difference), and thus communication quality can be assured.

Further, when the line setting of the radio line L2 can be changed, control for changing the line setting of the radio line L2 is performed by the line setting management unit 130, and thus it is not necessary for one who performs maintenance of the radio line L2 to re-design the line setting of the radio line L2 and the line setting of the radio line L2 can be dynamically optimized.

Further, when the line setting of the radio line L2 cannot be changed, the alarm management unit 150 inputs the alarm notification to a host monitoring system, and thus one who performs maintenance of the radio line L2 can grasp the risk as regards the communication quality and review the design of the line setting as necessary.

Further, the line setting management unit 130 changes the line setting of the radio line L2 by decreasing the line bandwidth of the radio line L2 for transmitting other data (for instance, the second traffic) that does not utilize the traffic bonding and increasing the line bandwidth on the minimum bandwidth side of the radio line L2 belonging to the traffic bonding. By this configuration, the line bandwidth difference (the permissible line speed difference) between the radio lines L2 belonging to the traffic bonding can be optimized by adjusting the load of another traffic that does not utilize the traffic bonding.

Note that the present disclosure is not limited to the example embodiments described above and can be modified as appropriates without departing from the sprit and the scope of the present disclosure. For instance, when the radio line L2 belonging to the traffic bonding corresponds to the adaptive modulation, the line setting management unit 130 may change the line setting of the radio line L2 by changing the modulation method dynamically and adjusting the line bandwidth difference.

Further, in the aforementioned example embodiments, description has been made giving transmission of data in the radio circuit L2 as an example, however, the present disclosure can also be applied when transmitting data in the wired circuit L1.

Further, the line quality assurance propriety determination unit 132 determines whether or not the line setting of the radio line L2 can be changed based on, for instance, whether or not the designated bandwidth of the second traffic can be changed. Specifically, for instance, when there is a user setting in which the bandwidth cannot be changed due to the priority of the traffic being high, the line quality assurance propriety determination unit 132 determines that the line setting of the radio line L2 cannot be changed.

Further, for instance, when setting for assuring the line quality cannot be selected due to the settable range of the modulation method of the radio line L2 being limited, the line quality assurance propriety determination unit 132 determines that the line setting of the radio line L2 cannot be changed.

In the example embodiment described above, the present disclosure has been explained as a hardware configuration, however, it is not limited thereto. The present disclosure implements the procedure shown in the flowchart of FIG. 4 by causing a CPU (Central Processing Unit) to execute the computer program.

Further, the aforementioned program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

While the disclosure has been particularly shown and described with reference to example embodiments thereof, the disclosure is not limited to these example embodiments. It will be understood by those of ordinary skill in the art that various changes in form and details may be made therein without departing from the scope of the present disclosure.

This application is based upon and claims the benefit of priority from Japanese patent application No. 2019-063950, filed on Mar. 28, 2019, the entire contents of which are incorporated herein by reference.

### INDUSTRIAL APPLICABILITY

According to the present disclosure, it is possible to provide a radio packet transmission apparatus that assures communication quality more reliably, a radio packet transmission method, and a non-transitory computer readable medium.

### REFERENCE SIGNS LIST

100, 100A RADIO PACKET TRANSMISSION APPARATUS
110 TRANSMISSION-SIDE CIRCUIT
111 DIVIDING UNIT (DIVIDING MEANS)
112 LINE DISTRIBUTION UNIT (LINE DISTRIBUTION MEANS)
113 RADIO TRANSMISSION UNIT (RADIO TRANSMISSION MEANS)
120 RECEPTION-SIDE CIRCUIT
121 RADIO RECEPTION UNIT (RADIO RECEPTION MEANS)
122 ASSEMBLY UNIT
130 LINE SETTING MANAGEMENT UNIT (LINE SETTING MANAGING
MEANS)
131 LINE STATUS DETERMINATION UNIT
132 LINE QUALITY ASSURANCE PROPRIETY DETERMINATION UNIT
133 PERMISSIBLE LINE DIFFERENCE DETERMINATION UNIT
134 SETTING CHANGE CONTROL UNIT
140 MEMORY MANAGEMENT UNIT
150 ALARM MANAGEMENT UNIT (ALARM MANAGEMENT MEANS)
L1 WIRED LINE
L2 RADIO LINE

What is claimed is:

1. A radio packet transmission apparatus comprising:
dividing unit configured to divide data when transmitting the data utilizing traffic bonding and generating a plurality of divided data;
line distribution unit configured to distribute the plurality of the divided data into a plurality of radio transmission unit provided for respective radio lines;
radio transmission unit configured to transmit the divided data distributed by the line distribution unit to the radio line corresponding to the radio transmission unit among the radio lines belonging to the traffic bonding;
radio reception unit configured to receive assembly memory capacity information of an opposing-side station indicating capacity allocated for transmission of the data in a memory of a reception-side radio packet transmission apparatus; and
line setting management unit configured to control line setting of the radio line, wherein
the radio transmission unit inputs a line status notification indicating a status of a line setting of the corresponding radio line to the line setting management unit,
the radio reception unit inputs the assembly memory capacity information of the opposing-side station to the line setting management unit, and
the line setting management unit determines whether or not the line quality of the radio line can be assured based on the line status notification and the assembly memory capacity information of the opposing-side station, and performs control of changing the line setting of the radio line when determining that the line quality of the radio line cannot be assured.

2. The radio packet transmission apparatus according to claim 1, further comprising alarm management unit configured to input an alarm notification to a host monitoring system, wherein
the line setting management unit determines whether or not it is possible to change the line setting of the radio line when determining that the line quality of the radio line cannot be assured, and
the line setting management unit inputs, to the alarm management unit, a notification of outside-of-quality-assurance-range instructing to input the alarm notification to the host monitoring system when determining that the line setting of the radio line cannot be changed.

3. The radio packet transmission apparatus according to claim 1, wherein the line setting managing unit performs control of the line setting of the radio line by decreasing the line bandwidth of the radio line for transmitting data other than those that utilize the traffic bonding and increasing the line bandwidth on the minimum bandwidth side of the radio line belonging to the traffic bonding.

4. A radio packet transmission method comprising performing, by a radio packet transmission apparatus, the steps of:
dividing data when transmitting the data utilizing traffic bonding and generating a plurality of divided data;
distributing the plurality of the divided data into respective radio lines and transmitting the plurality of the divided data to the respective radio lines;
receiving assembly memory capacity information of an opposing-side station indicating capacity allocated for transmitting the data in a memory of a reception-side radio packet transmission apparatus;
acquiring a line status notification indicating a status of a line setting of each radio line; and
determining whether or not the line quality of the radio line can be assured based on the line status notification and the assembly memory capacity information of the opposing-side station, and changing the line setting of the radio line when determining that the line quality of the radio line cannot be assured.

5. The radio packet transmission method according to claim 4, wherein the radio packet transmission apparatus determines whether or not it is possible to change the line setting of the radio line when determining that the line quality of the radio line cannot be assured, and the radio packet transmission apparatus inputs an alarm notification to a host monitoring system when determining that the line setting of the radio line cannot be changed.

6. The radio packet transmission method according to claim 4, wherein the radio packet transmission apparatus changes the line setting of the radio line by decreasing the line bandwidth of the radio line for transmitting data other than those that utilize the traffic bonding and increasing the line bandwidth on the minimum bandwidth side of the radio line belonging to the traffic bonding.

7. A non-transitory computer-readable medium storing a program for causing a radio packet transmission apparatus to execute the processes of:
dividing data when transmitting the data to a radio transmission apparatus utilizing traffic bonding and generating a plurality of divided data;
distributing the plurality of the divided data into respective radio lines and transmitting the plurality of the divided data to the respective radio lines;
receiving assembly memory capacity information of an opposing-side station indicating capacity allocated for transmitting the data in a memory of a reception-side radio packet transmission apparatus;
acquiring a line status notification indicating a line status of the radio line; and
determining whether or not the line quality of the radio line can be assured based on the line status notification and the assembly memory capacity information of the opposing-side station, and changing the line setting of the radio line when determining that the line quality of the radio line cannot be assured.

8. The non-transitory computer-readable medium storing the program according to claim 7 for causing the radio packet transmission apparatus to execute the process of
determining whether or not it is possible to change the line setting of the radio line when determining that the line quality of the radio line cannot be assured, and inputting an alarm notification to a host monitoring system when determining that the line setting of the radio line cannot be changed.

9. The non-transitory computer-readable medium storing the program according to claim 7 for causing the radio packet transmission apparatus to execute, in the process of changing the line setting of radio line, the process of decreasing the line bandwidth of the radio line for transmitting data other than those that utilize the traffic bonding and increasing the line bandwidth on the minimum bandwidth side of the radio line belonging to the traffic bonding.
